(19) United States
(12) Patent Application Publication
(10) Pub. No.: US 2013/0000871 A1
(43) Pub. Date: Jan. 3, 2013

(54) Systems and Methods for Extending Operating Temperatures of Electronic Components

(76) Inventors: Ian Olson, Pullman, WA (US); Jerry J. Bennett, Moscow, ID (US); Timothy Ecklund, Spokane, WA (US); Gerald K. Hein, Pullman, WA (US)

(21) Appl. No.: 13/173,238

(22) Filed: Jun. 30, 2011

(51) Int. Cl. F28D 15/04; G06F 1/26; G05D 23/19

(52) U.S. Cl. 165/104.26; 713/300

(57) ABSTRACT

According to various embodiments, an electronic component, such as a processor, is thermally coupled to a heat sink via a heat pipe. The heat pipe may contain a working fluid configured to freeze below a threshold temperature corresponding to the minimum operating temperature of the electronic component. Accordingly, if the temperature of the electronic component and/or the working fluid is below the threshold temperature, then the working fluid freezes, decreasing the amount of thermal energy transferred from the electronic component to the heat sink. The electronic component may self-heat until it is at least above the threshold temperature. Above the threshold temperature, the working fluid is in a fluid phase and increases the amount of thermal energy transferred from the electronic component to the heat sink via the heat pipe, and thereby reducing the temperature of the electronic component.

### TECHNICAL FIELD

This disclosure relates generally to systems and methods for heat sink assemblies. Specifically, a heat sink assembly includes a heat pipe configured to decrease heat transfer between a heat source and a heat sink below a threshold temperature and to increase heat transfer between a heat source and a heat sink above the threshold temperature.

### BRIEF DESCRIPTION OF THE DRAWINGS

Non-limiting and non-exhaustive embodiments of the disclosure are described, including various embodiments of the disclosure, with reference to the figures, in which:

FIG. 1A shows a conceptual diagram illustrating the transfer of thermal energy between a heat source and a heat sink below a threshold temperature.

FIG. 1B shows a conceptual diagram illustrating the transfer of thermal energy between a contact plate and a heat sink above a threshold temperature.

FIG. 2A illustrates one embodiment of an exploded view of a heat sink assembly including a heat sink base, heat pipes, and a contact plate.

FIG. 2B illustrates a first perspective view of the heat sink assembly of FIG. 2A.

FIG. 2C illustrates a second perspective view of the heat sink assembly of FIG. 2A.

FIG. 3 illustrates a perspective view of one embodiment of a heat sink assembly including a heat sink base thermally coupled to a heat sink having a plurality of fins.

FIG. 4 illustrates an exploded view of an industrial computer including a case, an electronic component, and a passive cooling system.

FIG. 5 illustrates an exemplary view of a partially assembled industrial computer including a passive cooling system thermally coupled to a heat sink having a plurality of fins mounted to the exterior of a case.

FIG. 6 illustrates one embodiment of the exterior of an industrial computer case with a mounted heat sink having a plurality of fins.

FIG. 7 illustrates an exemplary method for maintaining the temperature of an electronic component between a minimum operating temperature and a maximum operating temperature.

FIG. 8 illustrates an exemplary method for maintaining the temperature of a processor above a minimum operating temperature by causing the processor to execute low priority instructions in order to increase the thermal energy generated by the processor.

### DETAILED DESCRIPTION

The present disclosure provides systems and methods for extending operating temperatures of electronic components. Electronics, such as processors, batteries, electronic circuits, discrete electronic components, and the like, may have minimum and maximum operating temperatures. For example, a processor may be configured to operate between 0° C. and 80° C. A heat sink may be coupled to an electronic component in order to prevent the temperature of the electronic component from exceeding its maximum operating temperature. The heat sink may be configured to transfer thermal energy generated by the processor to a fluid medium, such as the surrounding air.

A heat sink may be configured to increase transfer of thermal energy. While this heat sink may ensure that an electronic component does not exceed a maximum operating temperature, this heat sink does not prevent an electronic component from dropping below a minimum operating temperature.

According to one embodiment of the present disclosure, a heat sink assembly includes a heat sink base, a contact plate, and a heat pipe. A heat source, such as an electronic component, may be thermally coupled to the contact plate, and the contact plate may be thermally coupled to the heat sink base via the heat pipe. According to various embodiments, the heat pipe may include a sealed hollow pipe. The heat pipe may house a working fluid configured to transfer heat from one end of the heat pipe to the other under certain conditions.

According to various embodiments, the working fluid has a low thermal resistance when in a fluid state and a high thermal resistance when in a solid state. Accordingly, when the heat pipe is above a threshold temperature, the thermal resistance of the heat pipe is low and the rate at which thermal energy is transferred from the heat source to the heat sink via the heat pipe is increased. When the temperature of the working fluid drops below the threshold temperature it freezes and the thermal resistance of the heat pipe increases. When the working fluid is frozen, the rate at which thermal energy is transferred from the electronic component to the heat sink via the heat pipe is reduced.

According to various embodiments, the threshold temperature at which the working fluid becomes a solid may approximately correspond to the minimum operating temperature of an electronic component. For example, a processor specifying an operating temperature between 0° C., and 100° C. may be thermally coupled to a contact plate. A heat pipe may thermally couple the contact plate to a heat sink. As long as the temperature remains above 0° C., the working fluid within the heat pipe may be configured to remain a fluid, increasing the efficiency of the transfer of thermal energy through the heat pipe to the heat sink. If the temperature falls below 0° C. the working fluid within the heat pipe may freeze, and may thus decrease the efficiency of the transfer of thermal energy through the heat pipe to the heat sink. Accordingly, the thermal energy generated by the processor will begin to heat the processor rather than be dissipated into the air by the heat sink. Effectively, the processor generates sufficient heat at temperatures below 0° C. to maintain the temperature of the processor above the minimum operating temperature.

According to various embodiments, the working fluid may be configured to freeze and inhibit heat transfer several degrees above the minimum operating temperature of the electronic component. Returning to the example above, the working fluid may be configured to freeze at 10° C. in order to ensure that the actual temperature of the processor remains above its minimum operating temperature of 0° C.

A processor may generate more heat in an active state than in an idle state. For example, a processor in an idle state may generate 10 watts of thermal energy and in an active state may generate 60 watts of thermal energy. Even with a heat pipe minimizing the rate at which thermal energy is transferred to a heat sink, if the ambient temperature is too low, a processor may not be able to generate sufficient heat in an idle state to remain above a minimum operating temperature. According to various embodiments, a temperature-monitoring program may cause the processor to execute arbitrary instructions in order to force the processor into an active state.

For example, a processor may have an operating temperature range between 0° C. and 75° C. An associated heat sink assembly, as described herein, may be configured with a working fluid configured to freeze and reduce the transfer of thermal energy at 10° C. A temperature monitoring program may be configured to cause the processor to execute arbitrary instructions in order to transition the processor from an idle state to an active state if the temperature drops below 5° C. As the temperature of the processor exceeds 10° C., the working fluid may transition to a fluid, ensuring that the temperature of the processor does not exceed 75° C.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. In particular, an “embodiment” may be a system, an article of manufacture (such as a computer-readable storage medium), a method, or a product of a process.

The phrases “connected to” and “in communication with” refer to any form of interaction between two or more components, including mechanical, electrical, magnetic, and electromagnetic interaction. Two components may be connected to each other even though they are not in direct contact with each other and even though there may be intermediary devices between the two components.

Some of the infrastructure that can be used with embodiments disclosed herein is already available, such as: processors, microprocessors, microcontrollers, programming tools and techniques, digital storage media, battery and other mobile power sources, analog-to-digital converters, and communications networks and associated infrastructure. Processors may include a special purpose processing device such as an ASIC, PAL, PLA, PLD, Field Programmable Gate Array, or other customized or programmable device. The processor may also include a computer-readable storage device such as non-volatile memory, static RAM, dynamic RAM, ROM, CD-ROM, disk, tape, magnetic, optical, flash memory, or other computer-readable storage medium.

As used herein, a software module or program may include any type of computer instruction or computer executable code located within or on a computer-readable storage medium. A program may, for instance, comprise one or more physical or logical blocks of computer instructions, which may be organized as a routine, program, object, component, data structure, etc., that performs one or more tasks or implements particular abstract data types. Additionally, software, firmware, and hardware may be interchangeably used to implement any given function described herein.

In some cases, well-known features, structures, or operations are not shown or described in detail. Furthermore, the described features, structures, or operations may be combined in any suitable manner in one or more embodiments. The components of the embodiments, as generally described and illustrated in the figures herein, could be arranged and designed in a wide variety of different configurations. In addition, the steps of the described methods do not necessarily need to be executed in any specific order, or even sequentially, nor need the steps be executed only once, unless otherwise specified.

The embodiments of the disclosure are best understood by reference to the drawings, wherein like parts are designated by like numerals throughout. In the following description, numerous details are provided to give a thorough understanding of various embodiments; however, the embodiments disclosed herein can be practiced without one or more of the specific details, or with other methods, components, materials, etc. In other instances, well-known structures, materials, or operations are not shown or described in detail to avoid obscuring aspects of this disclosure.

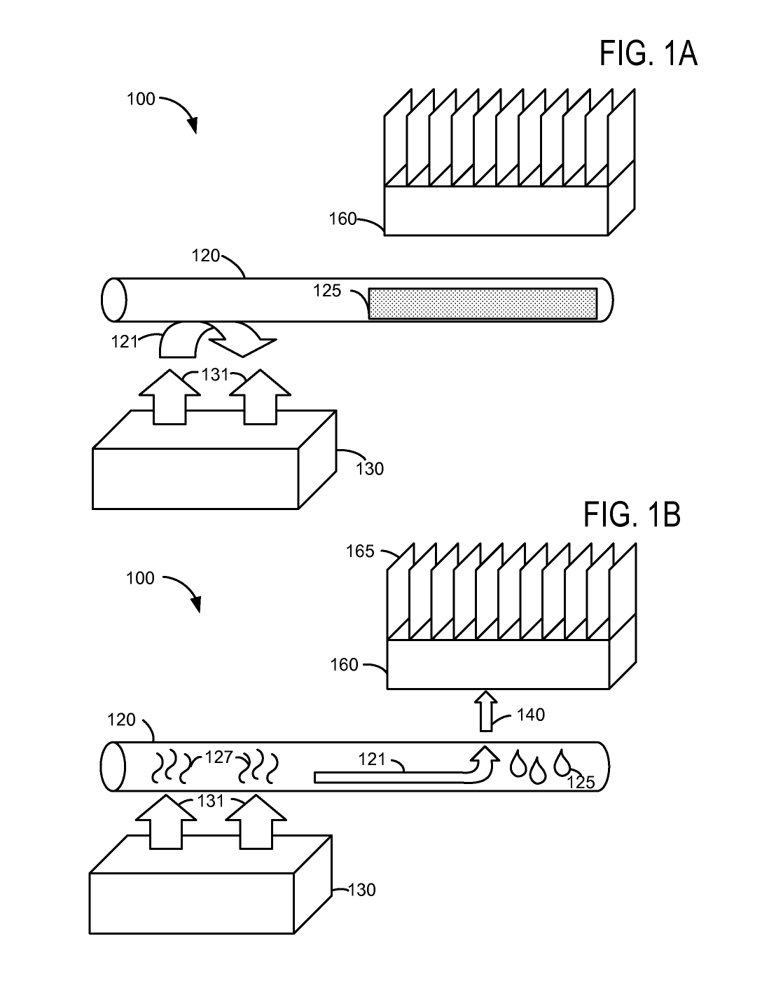

FIG. 1A illustrates a conceptual embodiment of a block diagram of a system 100 illustrating a heat pipe 120 that is thermally coupled to a heat source 130 and a heat sink 160. In FIG. 1A, the working fluid 125 is frozen, thus reducing the rate at which thermal energy is transferred between heat source 130 and heat sink 160. Working fluid 125 may be configured to freeze at temperatures below a threshold corresponding to the minimum operating temperature of an electronic component, which may represent heat source 130. With working fluid 125 frozen, heat pipe 120 may reduce, perhaps significantly, the transfer of thermal energy 131 from heat source 130 to heat sink 160. Arrow 121 illustrates that heat may be retained by or near heat source 130 while working fluid 125 is frozen.

FIG. 1B illustrates the conceptual embodiment of system 100, as shown in FIG. 1A; however, in FIG. 1B the working fluid 125 and 127 is a fluid. In a fluid state, working fluid transfers thermal energy at a greater rate between heat source 130 and heat sink 160. As thermal energy 131 is transferred from heat source 130 to working fluid 127 in the hot end of heat pipe 120, gaseous working fluid 127 may flow, at 121, from the hot end of heat pipe 120 to the cold end of heat pipe 120. As thermal energy 140 is transferred from the working fluid 127 to heat sink 160, working fluid 127 may condense and return to a working fluid 125. Thermal energy 140 absorbed by heat sink 160, may ultimately dissipate into the surrounding air. Fins 165 may be used to increase the surface area of heat sink 160, and thus increase the ability of heat sink 160 to dissipate thermal energy.

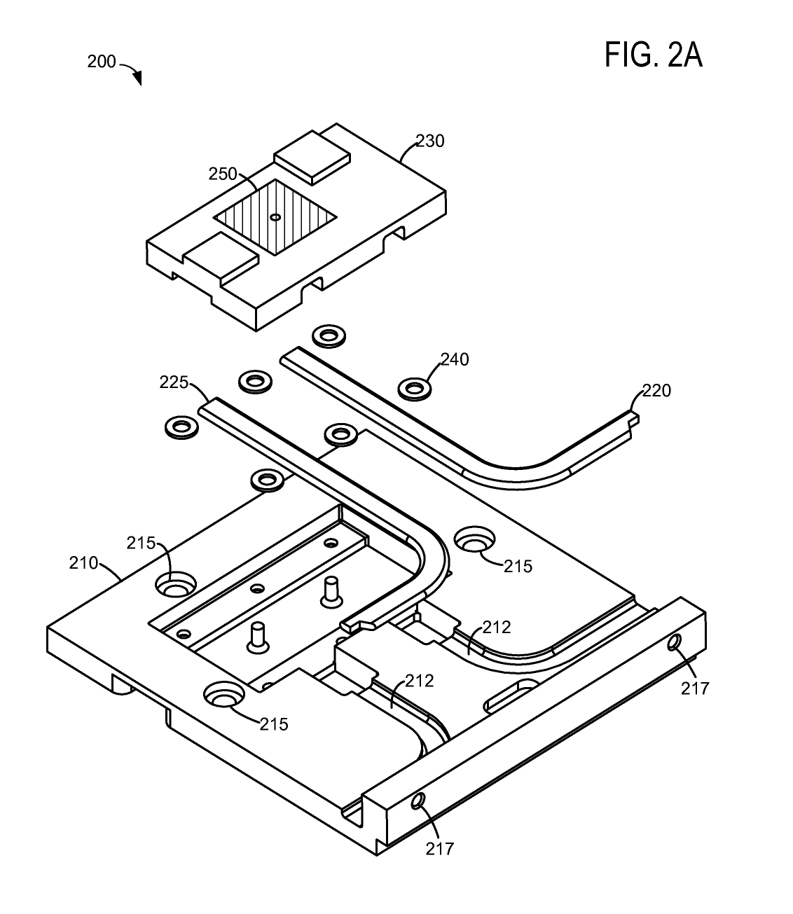

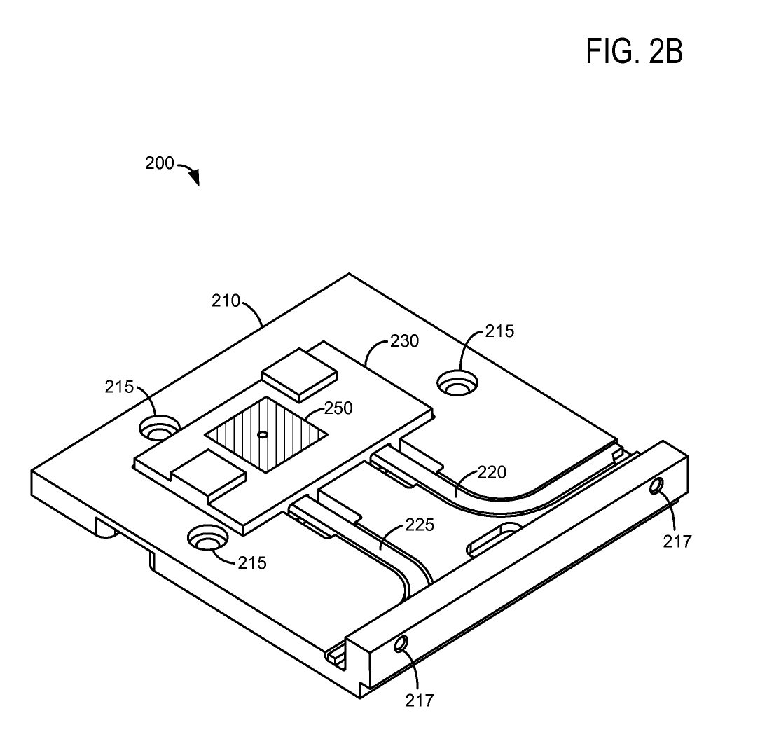

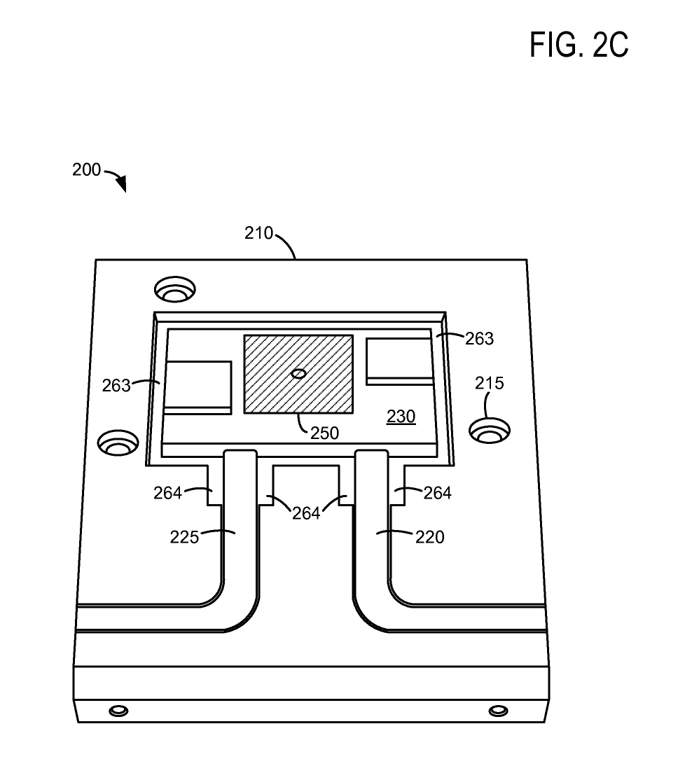

FIGS. 2A, 2B, and 2C illustrate one embodiment of a heat sink assembly 200 including a heat sink base 210, a contact plate 230 thermally insulated by air gap 263 from heat sink base 210, and heat pipes 220 and 225 configured to thermally couple contact plate 230 to heat sink base 210. FIG. 2A illustrates one embodiment of an exploded view of heat sink assembly 200 including heat sink base 210, heat pipes 220 and 225, and contact plate 230. According to various embodiments, heat sink base 210 may include various mounting features 215 for securing heat sink base 210 within a computer enclosure. Additionally, heat sink base 210 may include one or more connecting features 217 for thermally coupling an additional heat sink, such as a heat sink with one or more fins.

As illustrated in FIG. 2A, heat sink base 210 may include grooves 212 specifically configured to receive the ends of one or more heat pipes 220 and 225. Additionally, contact plate 230 may be configured to at least partially nest within heat sink base 210, without being directly thermally coupled to heat sink base 210. For example, washers 240, having a high thermal resistance, may allow contact plate 230 to be physically coupled to heat sink base 210 without being directly thermally coupled to heat sink base 210. Alternatively, contact plate 230 and heat sink base 210 may be physically separate as well.

According to various embodiments, contact plate 230 may be configured to receive an electronic component, such as a processor. As illustrated, contact patch 250 is configured to thermally connect an electronic component to contact plate 230. Heat pipes 220 and 225 may be configured to thermally couple contact plate 230 to heat sink base 210. According to various embodiments, any number of heat pipes may be used for a specific application, including a single heat pipe.

A supplementary heat sink having any of a variety of configurations may be attached to heat sink base 210 via connecting features 217. As such, heat sink base 210 may be located within a computer enclosure, and still be coupled to a heat sink with one or more fins located outside of a computer enclosure, allowing for heat to be dissipated more efficiently to the surrounding air. Heat sink base 210 may be constructed of any of a variety of materials known to efficiently conduct thermal energy, such as copper or aluminum.

Contact plate 230 may be of any shape and/or size, as appropriate, to allow a sufficient thermal contact with a chosen electronic component and with one or more heat pipes. As illustrated, contact patch 250 is configured to thermally couple a processor to contact plate 230; however, contact patch 250 and/or contact plate 230 may be modified to accommodate any of a wide variety of electronic components. Additionally, contact plate 230 may be constructed of any of a wide variety of materials known to have a relatively low thermal resistance, such as copper and aluminum. Additionally, corrosion-resistant metals, such as nickel, may be used to plate the various components of heat sink assembly 200.

Heat pipes 220 and 225 may be configured with any shape and/or size and tuned for a specific operating temperature range. According to various embodiments, heat pipes 220 and 225 are configured as sealed pipes having relatively thin walls constructed of a material with a low thermal resistance. Additionally, heat pipes 220 and 225 may contain a working fluid, such as acetone, ethanol, ammonia, and/or water. According to various embodiments, the heat pipe may be tuned to operate as desired over a given temperature range based on the amount and type of working fluid employed. For example, a working fluid may be chosen with a freezing point corresponding to the minimum operating temperature of a specific electronic component.

Heat pipes 220 and 225 are configured with cold ends (the ends attached to heat sink base 210) and hot ends (the ends attached to contact plate 230). Heat pipes 220 and 225 may be configured to rely on gravity to force condensed working fluid to return from the cold end to the hot end. According to such an embodiment, the cold ends of heat pipes 220 and 225 may be elevated relative to the hot ends. Alternatively, heat pipes 220 and 225 may include an internal wick structure configured to draw the liquid working fluid from the cold end to the hot end by exerting a capillary pressure on the working fluid.

At temperatures above the working fluid's freezing point, heat pipes 220 and 225 may be able to transfer thermal energy from the hot end to the cold end with greater efficiency than an equivalent cross-section of solid copper. Accordingly, the rate at which thermal energy is transferred from contact plate 230 to heat sink base 210 is increased when the temperature of the working fluid is above freezing. At temperatures below the working fluid's freezing point, heat pipes 220 and 225 have a relatively high thermal resistance, thus reducing the efficiency of transfer of thermal energy from contact plate 230 to heat sink base 210.

According to various embodiments, as the temperature of contact plate 230 (mirroring the temperature of an attached electronic component) drops below a threshold temperature, the working fluid located in the cold ends of heat pipes 220 and 225 will freeze and greatly reduce the rate at which thermal energy is transferred from contact plate 230 to heat sink base 210. The electronic component attached to contact plate 230 may then begin to self-heat. As the temperature of contact plate 230 increases, the working fluid located in the cold ends of heat pipes 220 and 225 may begin to melt and flow to the hot ends where it may vaporize. The rate at which thermal energy is transferred from contact plate 230 to heat sink base 210 will increase again, ensuring that the temperature of the electrical component does not exceed its maximum operating temperature.

Mounting features 215 may be configured to allow heat sink base 210 to be mounted within a computer enclosure. Similarly, connecting features 217 may be configured to allow a supplementary heat sink to be attached to heat sink base 210. According to various embodiments, contact plate 230 is configured to physically attach to heat sink base 210 without being in direct thermal contact. Air gap 263 inhibits the transfer of thermal energy from heat pipes 220 and 225 to heat sink base 210. Contact plate 230 may include one or more contact patches 250 configured to thermally couple one or more electronic components to contact plate 230.

Heat pipes 220 and 225 may be configured according to any combination of the previously described embodiments. Specifically, heat pipes 220 and 225 may be configured to efficiently transfer thermal energy from contact plate 230 to heat sink base 210 above a threshold temperature. Below the threshold temperature, heat pipes 220 and 225 may reduce the efficiency of the transfer of thermal energy from contact plate 230 to heat sink base 210. As previously described, this may be accomplished by using a working fluid configured to freeze at a desired temperature.

As illustrated in FIG. 2C, air moats 264 separate heat pipes 220 and 225 from heat sink base 210. According to various embodiments, the quantity and type of working fluid may be selected in order to tune heat pipes 220 and 225 to operate as desired for a given temperature range. The size of air moats 264 may be configured to tune heat pipes 220 and 225 to operate as desired within a specific temperature range. For instance, the size of air moats 264 may determine the separation between heat sink base 210 and heat pipes 220 and 225.

According to one embodiment, heat sink assembly 200 may be configured to maintain a processor coupled via contact patch 250 to contact plate 230 between 5° C. and 70° C. The working fluid within heat pipes 220 and 225 may be configured to freeze at approximately 5° C., below which temperature heat pipes 220 and 225 may have reduced effectiveness in transferring thermal energy from contact plate 230 to heat sink base 210. The processor may generate sufficient thermal energy to self-heat and maintain its temperature (and the temperature of contact plate 230) above the minimum operating temperature. Above 5° C., the working fluid may allow heat pipes 220 and 225 to transfer thermal energy from contact plate 230 to heat sink base 210, thereby maintaining the temperature of the processor below 70° C. According to various embodiments, the point at which the working fluid freezes and decreases the transfer of thermal energy between contact plate 230 and heat sink base 210 may be configured to be several degrees above the minimum operating temperature of the processor. The size of air moats 264 may be adjusted to suit a specific application and temperature range.

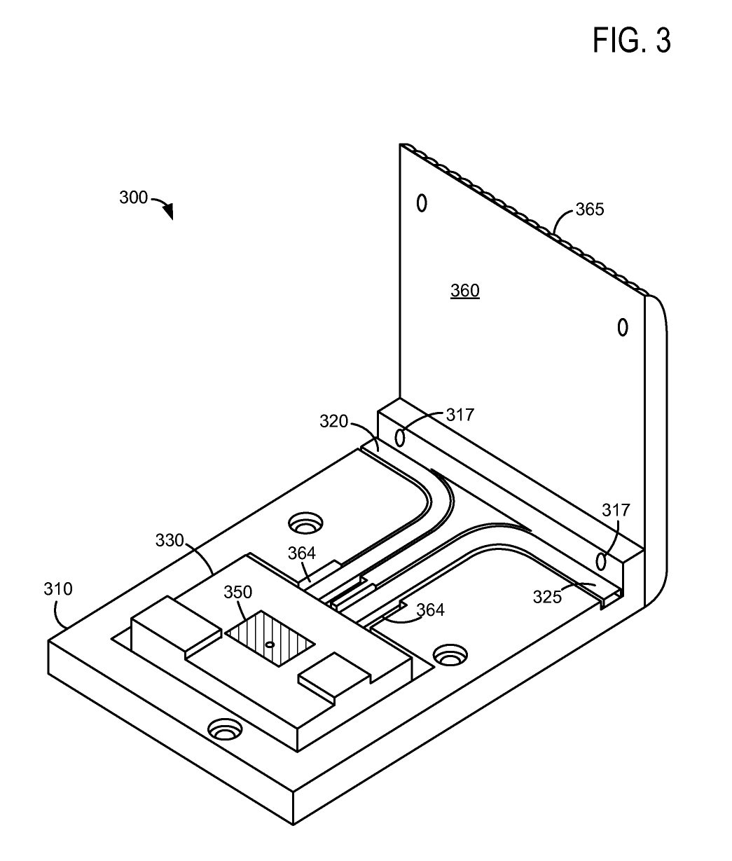

FIG. 3 illustrates one embodiment of a heat sink assembly 300, including a heat sink base 310 thermally coupled to a heat sink 360 via connection members 317. As illustrated, a contact plate 330 may be nested within, but thermally insulated from, heat sink base 310. Contact plate 330 may include a contact patch 350 configured to receive an electronic component. Heat pipes 320 and 325 may thermally couple contact plate 330 to heat sink base 310. According to various embodiments and as previously described, heat pipes 320 and 325 may be configured with a working fluid specifically tuned to maintain contact plate 330 between a minimum operating temperature and a maximum operating temperature. Air moats 364 may allow additional tuning to ensure that contact plate 330 remains between the minimum and maximum operating temperatures. Heat sink 360 may include a plurality of fins 365 configured to allow heat to be dissipated into the surrounding air quicker. Heat sink base 310 and heat sink 360 may be manufactured and configured according to any known heat sink configuration.

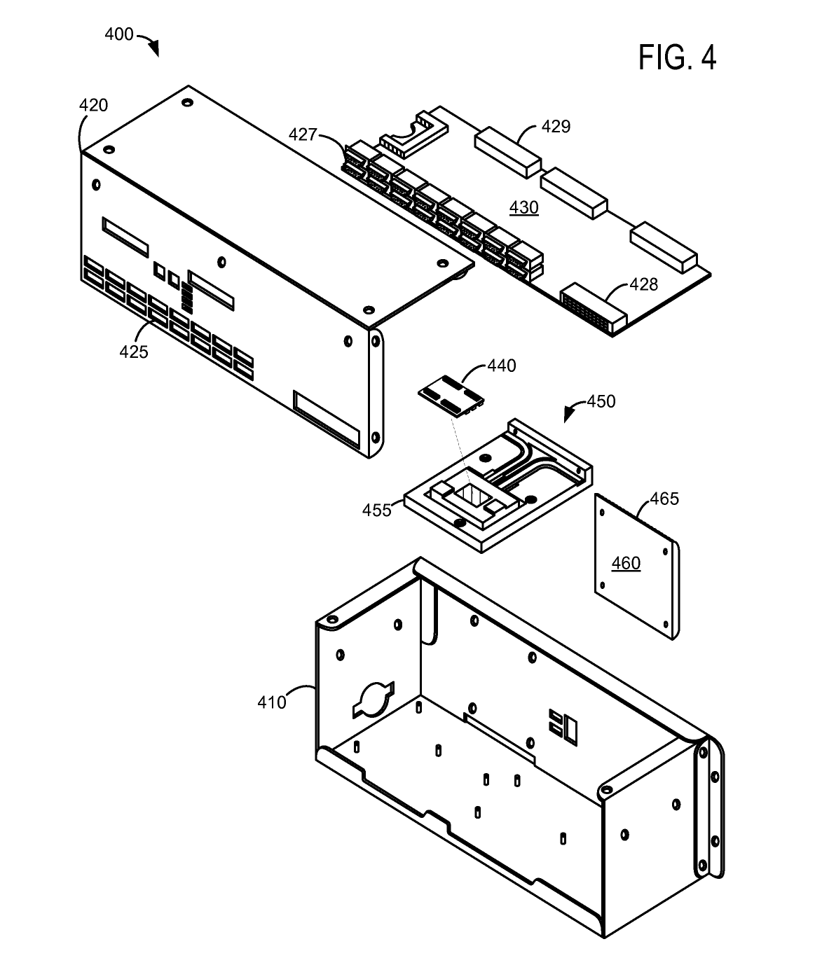

FIG. 4 illustrates an exploded view of an industrial computer 400, including a two-piece case 410 and 420 and various components housed therein, including a heat sink assembly 450, a heat generating electronic component 440, and a printed circuit board (PCB) 430 including various connectors 427, 428, and 429. Connectors 427, 428, and 429 may be connected to a circuit board 430. Industrial computer 400 may include an external heat sink with 460 including various heat-dissipating fins 465 configured to be thermally coupled to a heat sink base 455 of heat sink assembly 450. Case 420 may include various ports 425 for routing cables and connectors. Heat sink assembly 450 may be configured to operate according to any combination of the variously described embodiments.

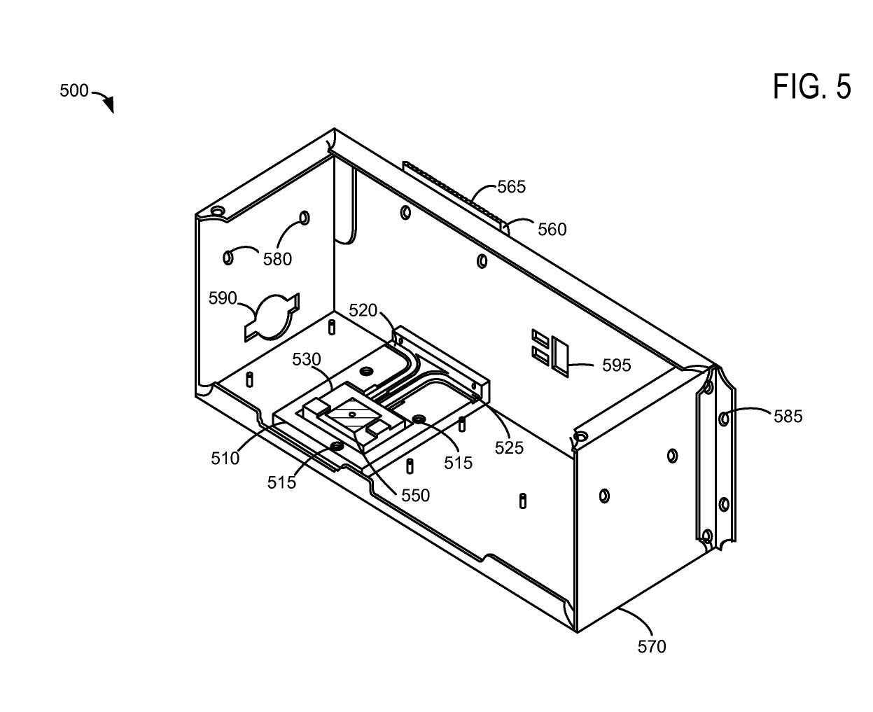

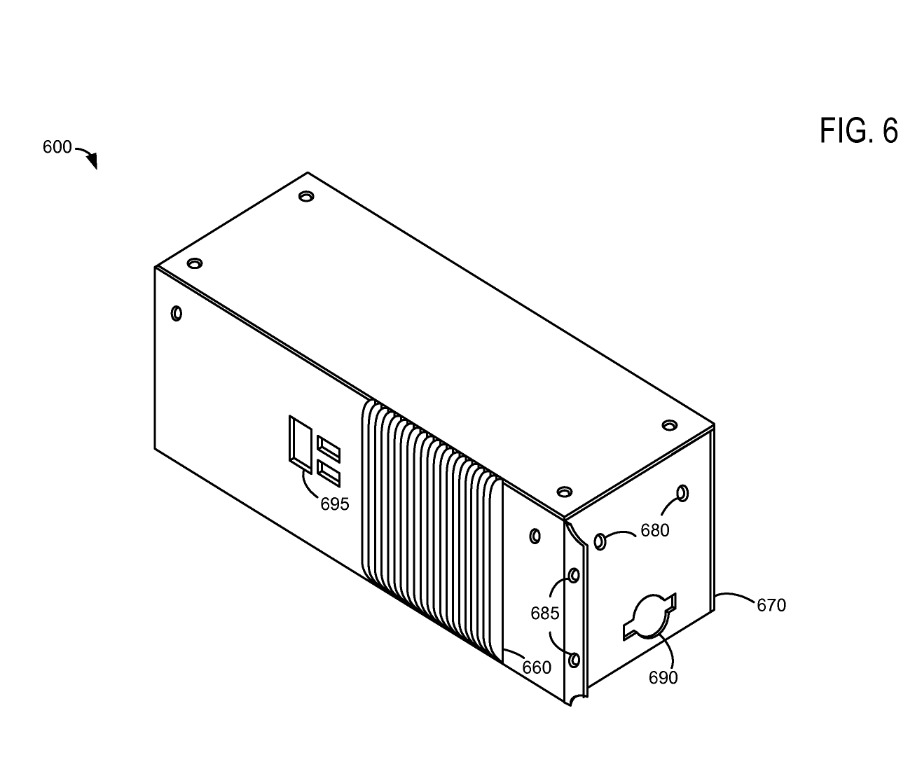

FIG. 5 illustrates an exemplary view of a partially assembled industrial computer 500, including a part of a two-piece case 570. As illustrated, a heat sink base 510 may be mounted to case 570 via mounting features 515. Additionally, an external heat sink 560 thermally coupled to heat sink base 510 may be mounted to the exterior of case 570. Fins 565 may allow heat generated by an electronic component to be efficiently transferred to the air surrounding industrial computer 500.

Case 570 may include various features, such as mounting holes 585 for mounting industrial computer 500, openings 580 and 590 for routing power and/or other connection cables, and various other openings 595 for cables and/or connectors. Industrial computer 500 may include a heat sink assembly configured to maintain an electronic component, such as a processor, between a minimum and maximum operating temperature.

Similar to previously described embodiments, the heat sink assembly may include a contact plate 530 configured to be thermally coupled to an electronic component via contact patch 550. According to various embodiments, contact plate 530 may be thermally coupled to heat sink base 510 via heat pipes 520 and 525. Heat pipes 520 and 525 may be configured according to any of the variously described embodiments.

Specifically, heat pipes 520 and 525 may house a working fluid selected to increase the transfer of thermal energy between contact plate 530 and heat sink base 510 above a threshold temperature and decrease the transfer of thermal energy between contact plate 530 and heat sink base 510 below the threshold temperature. That is, at temperatures above a threshold, thermal energy generated by an electronic component in thermal contact with contact plate 530 may be efficiently transferred through heat pipes 520 and 525 to heat sink base 510. Fins 565 of heat sink 560 may ultimately dissipate the thermal energy generated by the electronic component into the surrounding air. At temperatures below the threshold, frozen working fluid within heat pipes 520 and 525 may reduce the efficiency of heat transfer from contact plate 530 to heat sink base 510. Thermal energy generated by the electronic component in thermal contact with contact plate 530 may heat the electronic component and contact plate 530 until the temperature rises above the threshold.

FIG. 6 illustrates an exemplary embodiment of the exterior of an industrial computer 600 in which a heat sink 660 is mounted to the case 670. Again, case 670 may include a wide variety of holes 680 and 685 and/or ports 690 and 695 in order to facilitate connections, cables, connectors, and the like. According to various alternative embodiments, a heat sink having a plurality of fins 660 may be replaced with any of a wide variety of heat sinks configured to dissipate heat, including heat sinks utilizing phase change cooling.

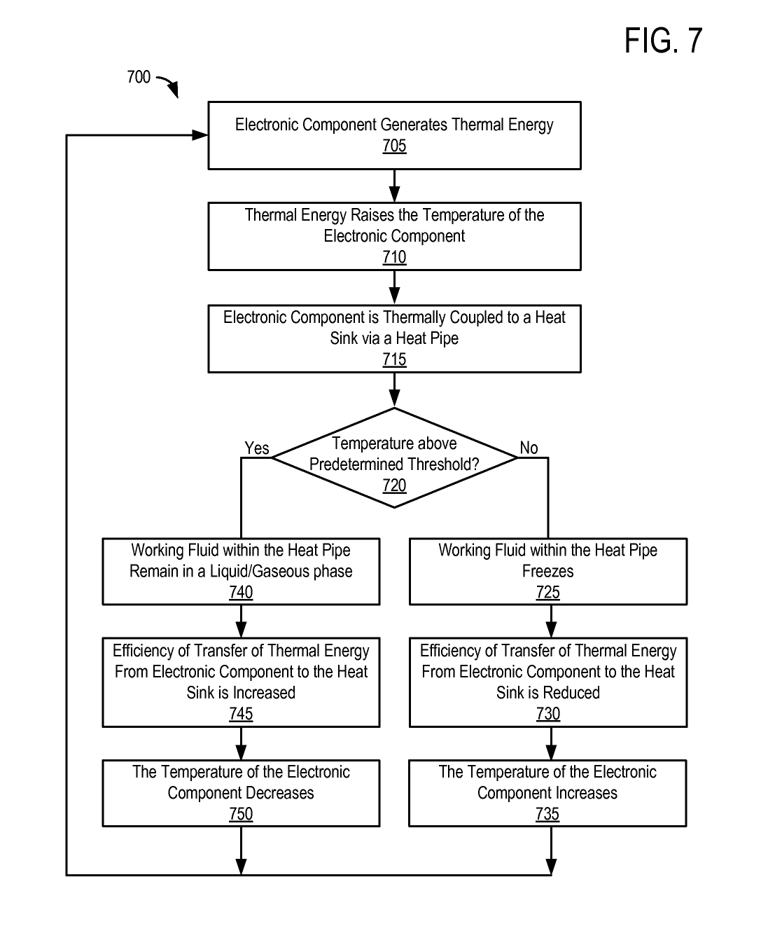

FIG. 7 illustrates an exemplary method 700 for maintaining the temperature of an electronic component between minimum and maximum operating temperatures. Under normal operating conditions, an electronic component generates thermal energy, at 705. This thermal energy raises the temperature of the electronic component, at 710. The electronic component may be thermally coupled to at least one heat pipe, at 715. According to various embodiments, an electronic component may be thermally mounted to a contact plate, in which case the temperature of the electronic component and the contact plate may be roughly the same. According to such embodiments, the at least one heat pipe may be thermally coupled to the contact plate instead of directly to the electronic component.

Similar to previously described embodiments, if the temperature is above a threshold, at 720, then the working fluid contained within the heat pipes may remain in a fluid phase as it transfers thermal energy from the hot end to the cold end of the heat pipe, at 740. Above the threshold temperature, the efficiency of the transfer of thermal energy from the electronic component to the heat sink is increased, at 745. As thermal energy is transferred from the electronic component to the heat sink, the temperature of the electronic component decreases, at 750.

If, however, the temperature is below a threshold, at 720, then the working fluid contained in the heat pipes may freeze, at 725. While the working fluid is frozen, the heat pipe may reduce the efficiency of transfer of thermal energy from electronic component to the heat sink, at 730. Thus, rather than being dissipated by the heat sink into the surrounding air, thermal energy generated by the processor remains in the processor (and/or contact plate), thus causing the temperature to increase, at 735. In other words, if the temperature is below a threshold, then the electronic component may generate sufficient heat in order to maintain a temperature above a minimum operating temperature.

According to various embodiments, the threshold temperature at which the working fluid freezes may be configured to correspond to the minimum operating temperature of the electronic component. According to various embodiments, the temperature at which the working fluid freezes may be equal to, or a number of degrees above, the minimum operating temperature of the electronic component. For example, if the operating range of a given electronic component is between 0° C. and 70° C., the working fluid, heat pipe configuration, heat sink size, heat sink materials, air gaps, and air moats may be adjusted in order to reduce a likelihood of the electronic component from operating outside of a specified temperature range (i.e., between 0° C. and 70° C.). Alternatively, the heat sink assembly may be configured to provide a significant buffer between a minimum and a maximum operating temperature. For example, the heat sink assembly may be configured to maintain the electronic component between 20° C. and 50° C. According to such an embodiment, the working fluid may be configured to freeze (i.e., transition to a solid phase) at about 20° C.

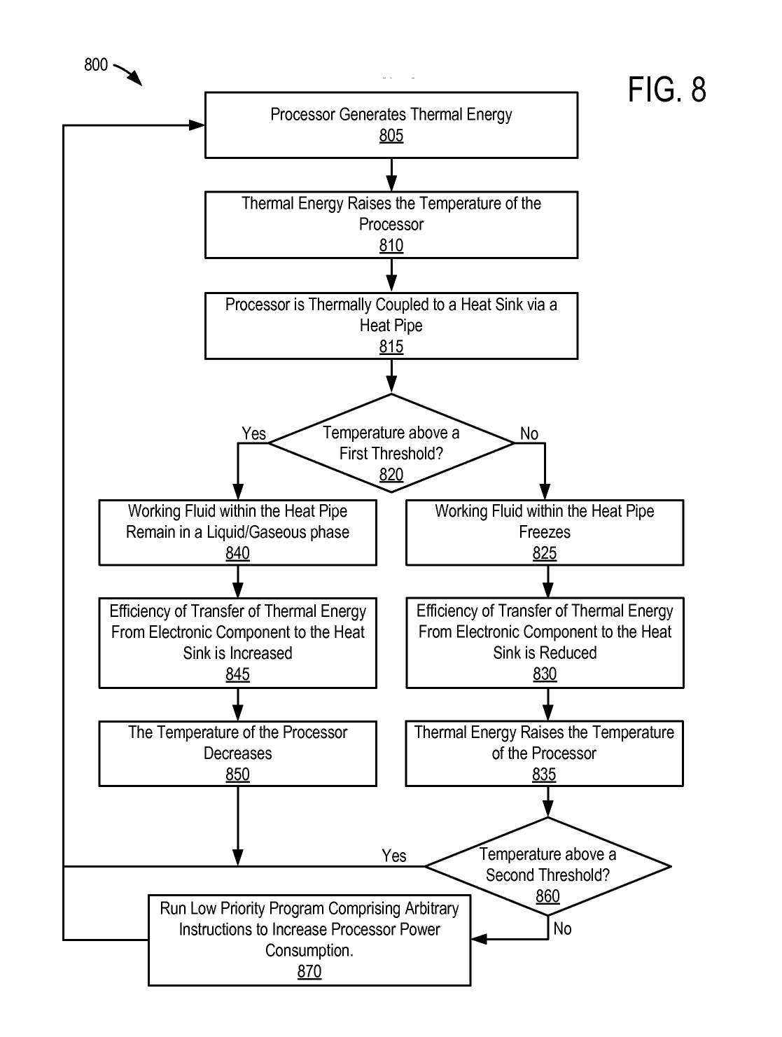

FIG. 8 illustrates an exemplary method 800 for maintaining a processor's temperature above a minimum operating temperature using both a heat sink assembly, as described herein, and by executing a low priority program in order to increase the rate at which a processor generates sufficient heat to maintain the processor above a minimum operating temperature. The processor generates thermal energy, at 805. The thermal energy raises the temperature of the processor, at 810. The processor may be thermally coupled to at least one heat pipe, at 815, potentially via a contact plate.

When the temperature is above a first threshold, at 820, the working fluid contained within the heat pipes may remain in a fluid phase as it transfers thermal energy from the hot end to the cold end of the heat pipe, at 840. Above the threshold temperature, the heat pipe may efficiently transfer thermal energy from the processor to a heat sink, at 845. As thermal energy is transferred from the processor to the heat sink, the temperature of the processor decreases, at 850.

If, however, the temperature is below the first threshold, at 820, then the working fluid contained in the heat pipes may freeze, at 825. The heat pipe may reduce the efficiency of the transfer of thermal energy from the processor to the heat sink, at 830. The thermal energy generated by the processor remains in the processor (and/or contact plate). The processor generates heat, at 835, in order to maintain its temperature above a minimum operating temperature.

In some situations, the ambient temperature may be too cold or the processor may generate insufficient heat in an idle state to maintain its own temperature above the minimum operating temperature. Accordingly, if the temperature is below a second threshold level, at 860, then a temperature-monitoring program may cause the processor to execute a low priority program, at 870.

According to various embodiments, a processor in an idle or standby state may only generate a few watts of thermal energy; however, in an active state the processor may generate many times the thermal energy. For example, an idle processor may only generate five watts of thermal energy, while the same processor may generate 50 watts in an active state. Thus, if the temperature is below the second threshold level, at 860, the processor may be placed into an active state, at 870, generating the necessary thermal energy to self-heat. According to various embodiments, by running a low priority program, the processor is free to begin executing more important instructions when requested.

According to various embodiments, the concept of forcing a processor to execute a low priority program in order to self-heat more quickly may be implemented independent of the heat sink assemblies described herein. That is, a temperature monitoring system may cause a processor connected to a traditional heat sink to transition from a low power state to a high power state in order to force the processor to self-heat as it consumes more power and therefore generates additional thermal energy. The above description provides numerous specific details for a thorough understanding of the embodiments described herein; however, one or more of the specific details may be omitted, modified, and/or replaced by a similar process or system.

What is claimed:

1. A method of maintaining the temperature of an electronic component between a minimum operating temperature and a maximum operating temperature, comprising:
generating thermal energy using an electronic component;
transferring at least a portion of the thermal energy generated by the electronic component to a heat sink using a heat pipe enclosing a working fluid and thermally coupled to the electronic component;
reducing the transfer of thermal energy from the electronic component to the heat sink via the heat pipe when the temperature of the working fluid is below a first threshold temperature;
utilizing a portion of the thermal energy generated by the electronic component to maintain itself above a minimum operating temperature of the electronic component;
increasing the transfer of thermal energy from the electronic component to the heat sink via the heat pipe when the temperature of the working fluid is above the first threshold temperature; and
dissipating a portion of the thermal energy generated by the electronic component to maintain the temperature of the electronic component below a maximum temperature.

2. The method of claim 1, wherein the electronic component is thermally coupled to the heat pipe via a contact plate.

3. The method of claim 1, wherein the first threshold temperature is approximately equal to the minimum operating temperature.

4. The method of claim 1, wherein the first threshold temperature is above the minimum operating temperature of the electronic component.

5. The method of claim 1, wherein the electronic component comprises a battery.

6. The method of claim 1, wherein the electronic component comprises a processor.

7. The method of claim 6, further comprising:
executing arbitrary instructions on the processor when the temperature of the processor is below a second threshold in order to increase a rate at which the processor generates thermal energy.

8. The method of claim 1, wherein the working fluid comprises one of acetone, ethanol, ammonia, and water.

9. A passive cooling system comprising:
a heat sink configured to dissipate thermal energy;
a heat pipe configured to thermally couple an electronic component to the heat sink;
a working fluid enclosed within the heat pipe, the working fluid configured to transition from a fluid state to a solid state at a threshold temperature, such that at temperatures below the threshold temperature, the working fluid is in the solid state and at temperatures above the threshold temperature the working fluid is in the fluid state;
wherein the heat pipe has a first thermal resistance when the working fluid is in a solid state; and
wherein the heat pipe has a second thermal resistance when the working fluid is in the fluid state, the second thermal resistance being lower than the first thermal resistance.

10. The passive cooling system of claim 9, wherein a section of the heat pipe extends through an air moat configured to reduce the transfer of thermal energy from the section of the heat pipe to the heat sink.

11. The passive cooling system of claim 10, wherein the length of the section of the heat pipe extending through the air moat is selected in order to control the rate at which the working fluid transitions between a solid state and one of the liquid state and the gaseous state.

12. The passive cooling system of claim 9, wherein the threshold temperature is approximately equal to a minimum operating temperature of the electronic component.

13. The passive cooling system of claim 9, further comprising a contact plate configured to thermally couple the heat pipe to the electronic component.

14. The passive cooling system of claim 9, wherein the threshold temperature is above the minimum operating temperature of the electronic device.

15. The passive cooling system of claim 9, wherein the electronic component comprises a battery.

16. The passive cooling system of claim 9, wherein the electronic component comprises a processor.

17. The passive cooling system of claim 9, wherein the working fluid comprises one of acetone, ethanol, ammonia, and water.

18. A method for extending a minimum operating temperature of a processor, comprising:
measuring the temperature of the processor;
determining if the temperature of the processor is below a threshold temperature; and
increasing the power consumption of the processor when it is determined that the temperature of the processor is below the threshold temperature by causing the processor to execute arbitrary instructions until the temperature of the processor is at least equal to the threshold temperature.

19. The method of claim 18, wherein the arbitrary instructions executed by the processor are executed at a low priority, such that another request to the processor for instruction processing postpones the execution of the arbitrary instructions.

20. The method of claim 18, wherein the threshold temperature corresponds to the minimum operating temperature of the processor.
